(19) United States
(12) Patent Application Publication
(10) Pub. No.: US 2007/0081847 A1
(43) Pub. Date: Apr. 12, 2007

(54) Method and computer program product for facilitating flattening a bound document in the open position

(75) Inventor: Olivier Acher, Monts (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/266,336

(22) Filed: Nov. 4, 2005

(30) Foreign Application Priority Data
Oct. 11, 2005 (FR) FR 05 53082

(51) Int. Cl. B41J 11/00

(52) U.S. Cl. 400/621

(57) ABSTRACT

A method and computer program product for scoring sheets of a document that includes at least two sheets assembled along a binding line includes scoring at least one fold line on a first sheet from one edge of the sheet to another edge of the sheet. The method and computer program product also include scoring, on a next sheet, at least one fold line parallel to the at least one fold line on the preceding sheet at a distance offset relative to the at least one fold line by an increment value that is proportional to a thickness of the next sheet. The method and computer program product also include repeating the preceding scoring step for other sheets of the document.

### CROSS-REFERENCE TO RELATED APPLICATIONS

The present application claims priority to French Patent Application No. FR 05 53082, filed Oct. 11, 2005, hereby incorporated by reference in its entirety, and is also related to U.S. patent application No. 10/507,217, filed Sep. 16, 2004, now published as U.S. Patent Publication No. 2005/0158107.

### FIELD OF THE INVENTION

The invention relates to a method and a computer program product for scoring pages of a bound document, which includes at least two sheets, leaves, or pages of paper, to produce fold lines that facilitate flattening of the bound document in an open position. The method may be applicable to many disciplines, such as the secretarial field, or private paper document creation.

### DISCUSSION OF THE BACKGROUND

The world of printing and publishing and the secretarial field, for example, is familiar with a certain number of ways of facilitating consulting a document comprising a plurality of pages. In particular, to facilitate turning the pages of a document having assembled together pages, the following is known:
leaving a blank area on the binding side, termed the “gutter”, so that the folded portion of the paper close to the binding remains legible;
when the bound document includes a rigid cover, forming a score line or fold in the cover to create an easy fold line for the cover and allow the cover to be folded. It will be recalled that the score line is a cut half way through the material, paper or board, which allows a fold line to be made easily without producing a tear.

Further, documents and reports amounting to a plurality of pages, when bound, cannot readily have their pages flattened while the document is being consulted, other than by folding the binding.

That difficulty is also met when such a document is to be photocopied, since the pages cannot readily be rendered flat.

This difficulty is exacerbated when the document is not bound but is stapled along the side, for example by means of three staples positioned in a line along the left hand side of the pages.

The problem is the same when the pages of a document, instead of being bound, are stapled together using a staple disposed, for example, in the top left hand comer, as is the case with many office documents.

One known solution for overcoming this disadvantage is to make a score line to define on each page easy fold lines which are disposed at a given distance from the binding. However, that solution is not satisfactory if the thickness of the document exceeds 1 mm (millimeter), and is impractical if the thickness of the document exceeds 5 mm. As the pages are turned, the paper tends to fold itself not at the score line, but at that level increased by the total thickness of the pages which have been turned.

### SUMMARY OF THE INVENTION

One object of the invention is to provide a method and a computer program product for scoring pages of a bound document to create fold lines that facilitate flattening of the pages when the bound document is in an open position.

This object may be achieved by a method and a computer program product for scoring pages of a bound document to produce fold lines, the document including at least two sheets to be assembled along a binding line. In a preferred embodiment, the method may use a peripheral device including means for printing a sheet of paper, means for scoring the sheet of paper and means for receiving instructions. Further, the method may include the following steps:

first scoring at least one first fold line on a first sheet from a first edge of the sheet to a second edge of the first sheet;

second scoring at least one next fold line on a next sheet, the next fold line being parallel to the at least one first fold line on the first sheet at a distance from a third edge of the sheet increased by an increment value that is proportional to a thickness of the next sheet;

repeating the second scoring step for other sheets of the document; and

assembling the sheets of the document.

In a preferred embodiment, the sheets may be assembled in the order in which the at least one fold line has been scored in them.

Preferably, the fold line is a straight line.

Each sheet may include at least one fold line (also termed a score line). However, it is also possible to provide a plurality of fold lines side by side and in parallel.

Preferably, the fold lines are placed beyond a zone in which the text is printed, so that the sheets can be read without problem.

In an alternative embodiment, the document may include an additional sheet that is the last sheet of the document, the last sheet not undergoing the step of forming at least one fold line.

In a possible implementation, the document may include two portions, a first portion in which the increment value is positive and a second portion in which the increment value is negative.

In a preferred embodiment, the at least one fold line may be parallel to the binding line.

In a preferred embodiment, the value of the increment is approximately in the range 50% to 300% of the thickness of the sheet onto which it is applied.

In a first variation, the edge of the sheet and the other edge of the sheet between which the fold line passes may be adjacent edges of the sheet. In other words, the fold line may be located in a corner of the sheet.

In a second variation, the edge of the sheet and the other edge of the sheet via which the fold line passes may be opposite edges of the sheet. In other words, the fold line may be located along the height or width of the sheet.

In a preferred embodiment, the fold line that is closest to the binding line may be at a distance of 5 mm or less from the binding line.

In a preferred embodiment, the fold lines may be parallel to one edge of each sheet.

In one implementation, the at least one fold line on each sheet may be produced by printing the fold line on the sheet in question using an absorbent ink which is capable of penetrating deep into the sheet of paper, then by exposing the sheet to a low power laser beam emitted, as a function of received instructions, at a wavelength absorbed by the regions inked with absorbent-ink, the power of the laser being sufficient to produce partial ablation of the paper at the regions inked with absorbent ink.

Partial ablation of the paper may allow the sheet of paper to be folded readily at the fold line, but without cutting the sheet of paper at the fold line.

In the preferred embodiment, the laser is one of the lasers in a matrix comprising a plurality of lasers, each laser being individually controlled. Instead of using a single laser, it is also possible to use a matrix of lasers, i.e. a matrix comprising a plurality of lasers, with each laser of the matrix being controlled individually so as to emit radiation on passing over a zone that is to be ablated. Thus, it is possible to perform the paper-cutting operations during a scan that is also used for printing on the sheet of paper. Such a matrix may comprise one or several hundreds of laser diodes. For example it may be made by assembling together a plurality of strips of diodes. The use of a matrix of lasers instead of a single laser thus may make it possible to avoid cutting taking place in a paper-handling stage subsequent to the inking stage, and consists in tracking the lines of cut on the paper using the matrix of lasers by causing the matrix of lasers to move together with the paper. It is thus possible to perform cutting in a “constant speed scanning” mode, which is the mode commonly used for the inking stage. It is thus possible to perform inking and cutting during the same paper-cutting stage. Total or partial cutting of the paper is thus obtained by a one or more scans of the matrix of lasers over the sheet of paper.

In a preferred embodiment, the at least one fold line on each sheet may be produced by mechanically cutting half way through the sheet, for example using a sharp blade.

In a preferred embodiment, at least one of the sheets of the document may be printed using the printer means of the device. Printing may be carried out before or after the step of producing fold lines on the sheet.

In a preferred embodiment, the margin, i.e. the space between the fold line and the printed zone, for two consecutive sheets may be less than or equal to the thickness of one of the two sheets. The margin may also be zero. It is thus possible to create a “gutter-free” effect which is particularly elegant and allows, for example, a photograph, an illustration or a large-sized table to be printed over a double page.

### BRIEF DESCRIPTION OF THE DRAWINGS

The invention will be better understood, and other advantages and features will become apparent from the following description given by way of non limiting illustration, made by way of the accompanying drawings in which:

FIG. 1 shows a top view of the first page of a document the pages of which are bound or stapled along a side edge of the pages and having a fold line in accordance with an embodiment of the invention; and

FIG. 2 shows a top view of the first page of a document the pages of which are stapled on one of the four corners of the sheet and have a fold line in accordance with an embodiment of the invention.

### DESCRIPTION OF THE PREFERRED EMBODIMENTS

A few examples are described below to illustrate possible operations of the method of the invention. To produce the various examples, printer and cutter devices may be used, such as those described in International Patent Application WO 2004/069542 A1 and U.S. patent application Ser. No. 10/507,217, which are each incorporated herein by reference in their entirety, and which describe a device allowing printing and cutting of a sheet of paper in an ink jet printer with a format equivalent to “office” printers. That device can be used to form fold lines or score lines on sheets for binding.

In a first example, a document is produced including at least two sheets (also termed pages), the sheets being for binding or stapling along one edge (for example the long left hand side of the sheets). By way of example, the sheets used may be in the A4 or “US legal” format (American format) routinely used in printers. However, the present invention is not limited to those size sheets and applies equally to other size sheets.

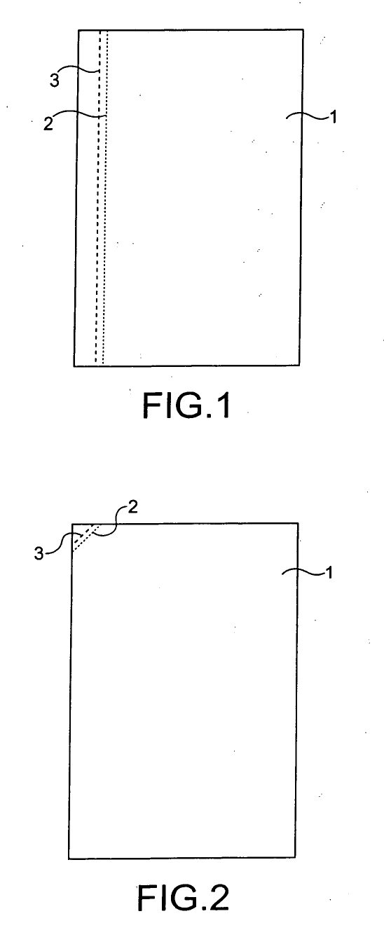

FIG. 1 shows a sheet 1 of a document to be bound, a fold line 2 (shown by a dotted line) on the left hand side of the sheet, along a long side of the sheet. The dashed line represents the binding line 3, i.e. the region at which the sheets may be bound or stapled together. As an example, three staples may be disposed on the binding line.

If the document includes only a few sheets, for example a number less than 10, and the sheets are thin, then the fold line may be formed at the same location on all of the sheets.

If the document includes many sheets, for example more than 10 in number, or the sheets are thick (for example sheets with a thickness of about 240 μm (micrometers)), the fold line is preferably offset on all of the sheets or, for example, on alternate sheets. As pages are turned, the paper will no longer tend to fold at the fold line, but at a position increased by the total thickness of the pages which have already been turned.

If several sheets had been shown in FIG. 1, the binding line 3 in dashed lines may be seen as being positioned at the same location on each sheet (as the binding is produced at the same level on each sheet) and the dotted line, representing the fold line 2, may be positioned at a region increased by a predetermined positive or negative increment (or in other words, increased by a positive increment or reduced by a positive increment). As an example, for all of the sheets of a document, the increment may be added to the distance between the binding line and the fold line for each sheet. The value of the increment may be selected to be substantially equal to the thickness of one sheet, so that each fold line is offset by the thickness of one sheet of paper for each successive page. The fold line is thus positioned at a distance which moves progressively away from the edge of the pages as the pages are turned in increasing order. The same is possible with an increment which increases as the pages are turned in the decreasing order (i.e. turned from the “back cover” to the “front cover”).

In the first solution given above, it should be noted that the document is preferably consulted with the last page being flat. This last page, or “back cover” does not need to have a fold line. The last page may also be formed from thicker board.

In a second example, a further disposition for the fold lines may be envisaged, consisting in incrementally changing the distance between the binding edge and the fold line for each sheet by a value which is substantially equal to the thickness of one sheet over a first portion of the document, then reducing the distance by the same value for each sheet over the last portion. Such a document can then be consulted with the “back cover” (last page) flat for the first portion, and with the first page (for example the cover page) disposed flat for the last portion of the document. It should be noted that it may be advantageous to define the first and last portions, corresponding respectively to a flat last cover page and a flat cover, to be either substantially in the middle of the document, for reasons of symmetry, or dependent on the contents of the document to render more tangible the fact of having differentiated the two portions of the document. As an example, it may be decided to cause the principal text of the document to be opened with the last page flat, and the annexes to be opened with the cover being flat.

In a third example, a document may be produced having sheets to be stapled at the top left hand corner. A fold line may be produced in the form of a line across the corner. In other words, the fold line may join two adjacent edges of the sheet, the two adjacent edges forming a corner. FIG. 2 shows an example of one of the sheets of the document, said sheet 1 including a binding line 3 (shown as a dashed line) representing the position of the staple, and a fold line 2 (dotted line) parallel to the binding line and located in the top left hand corner of the sheet. Here again, an increment is added to the distance between the binding line and the fold line for each successive sheet of the document, for example by a value equivalent to the thickness of one sheet of paper.

The method of the invention can produce a fold line located at a distance from the binding line that starts at a given value, and that is incremented for each page by a predetermined value, for example by a value equal to the thickness of the paper.

Advantageously, the incremental value may be a value in the range 50% of the thickness of the paper, to three times the thickness of the paper. The incremental value may be chosen as a function of the desired result. A small increment will encourage re-closure of the document, while a large increment favors flattening.

The presence of the fold lines means that the pages of the document remain in place when the document is open. In particular, the pages remain flat on the support on which the document is placed since the pages can be folded along the fold line, thereby facilitating reading the document or reproducing the document by photocopying.

The presence of these fold lines also makes it possible to reduce the dimensions of the margin on the side of the binding line. It will be recalled that this margin is an unprinted gutter disposed along the binding line to compensate for the fact that the pages curve when they are turned and so that the printed text remains legible. With the method of the invention, the margin may be positioned at values as low as 5 mm or less from the binding line. The margin between the fold line and the printed zone of the page (text or drawing) may also be reduced to a zero value, or at least less than or equal to the thickness of one sheet of paper. This can thus create a “gutter-free” effect which is particularly elegant. When the paper is printed on both sides, it is possible to produce gutter-free double pages, which means that a photograph or large illustration can span a double page without the binding deleteriously affecting and reducing the size available to the illustration.

To produce the fold lines described above, it is possible to use a printer and cutter device such as that described in International Patent Application WO 2004/069542 A1 and U.S. patent application Ser. No. 10/507,217, which are each incorporated herein by reference in their entirety. The fold lines may be obtained by printing the fold lines on each sheet of paper with an absorbent ink, and by exposing each sheet to the beam of a laser emitted at a wavelength absorbed by the regions inked with the absorbent ink. The laser is a low power laser, but has sufficient power to produce partial ablation of the paper along the fold lines. The characteristics of the absorbent ink and the laser are described in International Patent Application WO 2004/069542 A1 and U.S. patent application Ser. No. 10/507,217, which are each incorporated herein by reference in their entirety.

An embodiment of the present invention may also include a computer program product suitable for being received on a storage medium and including instructions capable of being used for programming a computer in such a manner as to perform the method of the present invention. The storage medium may include, but is not limited to: any type of disk including floppy disks, optical disks, CD-ROMs, magneto-optical disks, ROMs, RAMs, EPROMs, EEPROMs, instantaneous memories (“flash memories), magnetic or optical cards, or any type of medium suitable for storing electronic instructions.

The invention may also advantageously be used with a conventional program programmed in compliance with the teaching of the present specifications, as will be apparent to a person skilled in the art working in the field of computers. Appropriate coding of software can be prepared by competent programmers on the basis of the teaching in the present description, as will be apparent to a person skilled in the art working in the field of software. In particular, the computer program for cutting and printing in accordance with the present invention can be written in a variety of programming languages, including but not restricted to: C, C++, Fortran, and Basic, as will be apparent to the person skilled in the art having ordinary competence in this field. The invention may also be put into application by preparing application-specific integrated circuits or by connecting together a suitable network of conventional circuit components, as will be apparent to the person skilled in the art.

It is preferable to use word processing software or printer driver software to define the positions of the binding lines and the folding lines, their dimensions and their arrangements on the various sheets to obtain sheets which are properly bound and readily consultable. In particular, the document pagination and paper thickness may be used by the word processing software or software associated with the printer and cutter device to define the position of the binding lines and the fold lines on each sheet. It is thus possible to use a computer and software to suitably position the printed contents of each sheet (text, drawings, illustrations, etc) with the positioning of the fold lines and binding lines. Using software thus renders easy the use of a printer and cutter device as described in International Patent Application WO 2004/069542 A1 and U.S. patent application Ser. No. 10/507,217, which are each incorporated herein by reference in their entirety, allowing both the fold lines and the binding lines, which facilitate laying flat sheets in the document and printing the sheets of the document, to be carried out readily with one and the same device.

The software may allow the margin, i.e., the space between the fold line and the printed zone, to be correctly dimensioned to achieve the result to be obtained. As an example, the software may produce a zero value at the margin so that a large photograph can be positioned and printed over two consecutive sheets.

Thus, an embodiment of the present invention also includes a computer-based product that may be hosted on a storage medium and include instructions that can be used to program a computer to perform a process in accordance with the present invention. In particular, the computer program product according to the present invention can store a program, which, when executed by a computer, causes the computer to control a device to form fold lines and binding lines as discussed above, examples of which are shown in FIGS. 1-2 of the present document. The device can be a peripheral device, such as the one disclosed in U.S. patent application Ser. No. 10/507,217, now published as US 2005/0158107, which is hereby incorporated by reference. The storage medium can include, but is not limited to, any type of disk including floppy disks, optical disks, CD-ROM, magneto-optical disks, ROMs, RAMs, EPROMs, EEPROMs, Flash Memory, Magnetic or Optical Cards, or any type of media suitable for storing electronic instructions.

This invention may also be conveniently implemented using a conventional general purpose digital computer programmed according to the teachings of the present specification, as will be apparent to those skilled in the computer art. Appropriate software coding can readily be prepared by skilled programmers based on the teachings of the present disclosure as will be apparent to those skilled in the software art. In particular, the computer program product for forming fold lines and binding lines according to the present invention can be written in a number of computer languages including but not limited to C, C++, Fortran, and Basic, as would be recognized by those of ordinary skill in the art. The invention may also be implemented by the preparation of applications specific integrated circuits or by interconnecting an appropriate network of conventional component circuits, as will be readily apparent to those skilled in the art.

1. A method of scoring sheets of a document that includes at least two sheets assembled along a binding line, the method comprising the following steps:
first scoring at least one first fold line on a first sheet from a first edge of the first sheet to a second edge of the first sheet;
second scoring at least one next fold line on a next sheet, the next fold line being
parallel to the at least one first fold line on the first sheet and being offset relative to said at least one first fold line by an increment value that is proportional to a thickness of the next sheet;
repeating the second scoring step for other sheets of the document; and
assembling the first, next and other sheets of the document.

2. The method of claim 1, wherein the document includes an additional sheet that is a last sheet of the document, the additional sheet not undergoing the second scoring step.

3. The method of claim 1, wherein the document comprises two portions, a first portion in which the increment value is positive and a second portion in which the increment value is negative.

4. The method of claim 1, wherein the at least one next fold line is parallel to the binding line.

5. The method of claim 1, wherein the increment value is in a range of 50% to 300% of the thickness of the next sheet.

6. The method of claim 1, wherein the first edge of the first sheet and the second edge of the first sheet between which the first fold line passes are adjacent edges of the first sheet.

7. The method of claim 1, wherein the first edge of the first sheet and the second edge of the first sheet between which the first fold line passes are opposite edges of the first sheet.

8. The method of claim 1, wherein a fold line that is closest to the binding line is at a distance of 5 mm or less from the binding line.

9. The method of claim 1, wherein each fold line is parallel to one edge of each sheet.

10. The method of claim 1, wherein each of the first and second scoring steps further comprise:
printing with an absorbent ink capable of penetrating into the first and next sheets of paper; and
exposing the first and next sheets of paper to a laser beam emitted at a wavelength absorbed by the absorbent ink, a power of the laser beam being sufficient to partially ablate paper where the absorbent ink is printed.

11. The method of claim 10, wherein the laser beam is produced by a laser in a laser matrix comprising a plurality of lasers, each laser being configured to be controlled independently of all other lasers in the plurality of lasers.

12. The method of claim 1, wherein at least one of the sheets of the document is printed with a printing section of a peripheral device.

13. The method of claim 1, wherein a margin between a fold line and a printed region of a sheet for two consecutive sheets is less than or equal to a thickness of one of the two consecutive sheets.

14. The method of claim 12, wherein the peripheral device comprises a cutting section configured to cut the first and next sheet of paper and a receiving section configured to receive instructions.

15. A computer program product storing a program for scoring sheets of a document that includes at least two sheets assembled along a binding line, the program, when executed by a computer, causes a device to perform the following steps:
first scoring at least one first fold line on a first sheet from a first edge of the first sheet to a second edge of the first sheet;
second scoring at least one next fold line on a next sheet, the next fold line being parallel to the at least one first fold line on the first sheet and being offset relative to said at least one first fold line by an increment value that is proportional to a thickness of the next sheet; and
repeating the second scoring step for other sheets of the document.

16. The computer program product of claim 15, wherein the document includes an additional sheet that is a last sheet of the document, the additional sheet not undergoing the second scoring step.

17. The computer program product of claim 15, wherein the document comprises two portions, a first portion in which the increment value is positive and a second portion in which the increment value is negative.

18. The computer program product of claim. 15, wherein the at least one next fold line is parallel to the binding line.

19. The computer program product of claim 15, wherein the increment value is in a range of 50% to 300% of the thickness of the next sheet.

20. The computer program product of claim 15, wherein the first edge of the first sheet and the second edge of the first sheet between which the first fold line passes are adjacent edges of the first sheet.

21. The computer program product of claim 15, wherein the first edge of the first sheet and the second edge of the first sheet between which the first fold line passes are opposite edges of the first sheet.

22. The computer program product of claim 15, wherein a fold line that is closest to the binding line is at a distance of 5 mm or less from the binding line.

23. The computer program product of claim 15 wherein each fold line is parallel to one edge of each sheet.

24. The computer program product of claim 15, wherein the program, when executed by the computer, causes the device to perform each scoring step by:
printing with an absorbent ink capable of penetrating into the first and next sheets of paper; and
exposing the first and next sheets of paper to a laser beam emitted at a wavelength absorbed by the absorbent ink, a power of the laser beam being sufficient to partially ablate paper where the absorbent ink is printed.

25. The computer program product of claim 24, wherein the laser beam is produced by a laser in a laser matrix comprising a plurality of lasers, each laser being configured to be controlled independently of all other lasers in the plurality of lasers.

26. The computer program product of claim 15, wherein the program, when executed by the computer, causes the device to print at least one of the sheets of the document.

27. The computer program product of claim 15, wherein a margin between a fold line and a printed region of a sheet for two consecutive sheets is less than or equal to a thickness of one of the two consecutive sheets.

28. The computer program product of claim 15, wherein the program, when executed by the computer, causes the device to cut the first and next sheets of paper.

29. The computer program product of claim 15, wherein the program, when executed by the computer, causes the device to assemble the first, next and other sheets of the document along said binding line.
